(19) United States
(12) Patent Application Publication
(10) Pub. No.: US 2008/0245697 A1
(43) Pub. Date: Oct. 9, 2008

(54) Packaging system for carrying an item, preferably bulky and/or heavy items, and method for using the same

(76) Inventor: Alan Lerner, West End, NJ (US)

Correspondence Address: Allen R. Kipnes, Esq.;WATOV & KIPNES, P.C., P.O. BOX 247, Princeton Junction, NJ, 08550, US

(21) Appl. No.: 12/075,692

(22) Filed: Mar. 13, 2008

Related U.S. Application Data
(60) Provisional application No. 60/921,716, filed on Apr. 4, 2007.

(51) Int. Cl. B65D 85/00; B31B 19/60; B65D 73/00

(52) U.S. Cl. 206/525; 493/210; 206/461

(57) ABSTRACT

A packaging system for carrying an item, preferably bulky and/or heavy items, includes an enclosed container defining an interior cavity, and having a double wall corrugated construction forming an outer surface defining a length, a height and a depth and at least one perforating line circumscribing the outer surface of the container, wherein the at least one perforating line is oriented in a plane orthogonal to an axis of direction of the corresponding length, height or depth of the container. A method for using the packaging system, and a blank for forming the packaging system are also disclosed herein.

### FIELD OF THE INVENTION

The present invention relates generally to packaging, and more particularly to a packaging system for carrying an item, preferably bulky and/or heavy items, and a method for using the same.

### BACKGROUND OF THE INVENTION

Moving to a new residence or place of business can be a difficult and exhausting process. A move generally involves packing, transporting and unloading personal items ranging from furniture, appliances, equipment, clothing and other furnishings. Prior to loading a transport vehicle or shipping container, the furniture and other personal items are carefully wrapped and packed to avoid damage. Polished surfaces may be protected with bulk packing material such as bubble wraps, newspaper, Styrofoam-based materials, or cardboard. China and other more fragile items are packed in rigid boxes with bulk packing material to protect against breakage, scratches and chips in transit. Soft items may be packed in bags, suitcases or boxes.

Large items such as large flat screen televisions, framed artwork, framed mirrors, shelves, and furniture, are usually wrapped in thick quilted and durable blankets which serve as protective covers and cushioning to prevent soiling, scratches and minor dings. However, such blanket wraps cannot adequately protect larger items against physical damage from hard shocks, impacts or drops. To offer greater protection against physical damage, a moving crate is typically constructed to house and package large items for moving. The crate is typically custom-fabricated to match the dimensions of the large item, and to enclose the item on all sides.

Several disadvantages are associated with the use of moving crates. Moving crates must be custom-made and are generally constructed of heavy materials such as wood, which undesirably add more weight to the packaged item. The crates are expensive to make and use due to the cost of the materials, cost of construction and cost of disposal. The moving crate may have to be fabricated at a remote location and subsequently transported to the moving site, and then may need to be returned for reuse or disposed of in a proper manner. A further disadvantage is empty moving crates are relatively bulky and expensive to transport to the locations where they are needed. Once the item as packaged in the moving crate arrives at its destination, the moving crate must be dismantled to unload the item.

In view of the foregoing problems associated with moving furniture, equipment and other bulky and/or heavy items from one location to another, there remains a need for a packaging system for carrying an item such as bulky and/or heavy items, and method for using the same that is relatively lightweight, compact, cost efficient and less labor intensive to make and use than conventional custom fabricated moving crates. There is a need for a packaging system for carrying an item, preferably bulky and/or heavy items, and method for using the same, which enables the user to safely and securely package bulky and/or heavy items on-site in a cost effective and relatively simple manner. There is a further need for a packaging system for carrying an item, preferably bulky and/or heavy items, and method for using the same, which is designed to accommodate a range of different size items, while requiring minimal tools and method steps to implement.

### SUMMARY OF THE INVENTION

The present invention is generally directed to a packaging system for carrying an item, preferably bulky and/or heavy items, and a method for using the same. The packaging system of the present invention is relatively lightweight, compact, cost efficient and less labor intensive to make and use than conventional custom fabricated moving crates. The packaging system of the present invention has a construction with a bursting strength sufficient to support and carry bulky and/or heavy items for transport and storage, while safely securing the contents and protecting them from physical damage due to external shocks, impacts or drops. The packaging system of the present invention is readily adjusted to accommodate different size items using minimal tools and relatively little labor. In particular, the present invention enables the user to safely and securely package bulky and/or heavy items on-site for transport and carry in a cost effective and relatively simple manner, and is thus especially desirable for use by the moving industry and self-movers.

In one aspect of the present invention, there is provided a packaging system for carrying an item, preferably bulky and/or heavy items, which comprises:

an enclosed container defining an interior cavity, and having an outer surface defining a length, a height and a depth; and

at least one perforating line circumscribing the outer surface of the container, the at least one perforating line oriented in a plane orthogonal to an axis of direction of the corresponding length, height or depth of the container.

In another aspect of the present invention, there is provided a method for implementing a packaging system, which comprises:

obtaining a packaging system comprising:
(a) a container defining an interior cavity, and having an outer surface defining a length, a height and a depth; and
(b) at least one perforating line circumscribing the outer surface of the container, the at least one perforating line oriented in a plane orthogonal to an axis of direction of the corresponding length, height or depth of the container;

cutting along one of the at least one perforating line to yield first and second container members each having an open end in communication with an interior area;

inserting one end of a packaged item into the interior area of the first container member;

placing an opposing end of the item into the interior area of the second container member; and

engaging the two open ends of the first and second container members in a telescoping closure relationship wherein the item is enclosed within the interior areas of the telescoped first and second container members.

In a third aspect of the present invention, there is provided a blank for forming the packaging system described above.

### BRIEF DESCRIPTION OF THE DRAWINGS

The following drawings are illustrative of embodiments of the present invention and are not intended to limit the invention as encompassed by the claims forming part of the application.

FIG. 1 is a perspective view of a packaging system for one embodiment of the present invention;

FIG. 2 is perspective view of the packaging system implemented for carrying an item, preferably bulky and/or heavy items in accordance with the present invention;

FIG. 3 is a top plan view of the packaging system of FIG. 2 in accordance with the present invention;

FIG. 4 is a top plan view of the packaging system in a telescopic packaged state in accordance with the present invention; and

FIG. 5 is an elevation view of one embodiment of a cardboard blank for producing the packaging system in accordance with the present invention.

### DETAILED DESCRIPTION OF THE INVENTION

The present invention is directed to a packaging system for carrying an item, preferably bulky and/or heavy items, and a method for using the same. The packaging system of the present invention is relatively lightweight, compact, cost efficient and less labor intensive to make and use than conventional custom fabricated moving crates. The packaging system of the present invention has a construction with a bursting strength sufficient to support and carry bulky and/or heavy items for transport and storage, while safely securing the contents and protecting them from physical damage due to external shocks, impacts or drops. The present packaging system may be used to carry lightweight items as well.

The packaging system of the present invention is readily adjusted to accommodate different size items using minimal tools and relatively little labor. In particular, the present invention enables the user to safely and securely package bulky and/or heavy items on-site for transport and carry in a cost effective and relatively simple manner, and is thus especially desirable for use by the moving industry and self-movers.

In one aspect of the present invention, there is provided a packaging system for carrying an item, preferably bulky and/or heavy items, which includes an enclosed container defining an interior cavity, and having an outer surface defining a length, a height and a depth, and at least one perforating line circumscribing the outer surface of the container, wherein the at least one perforating line is oriented in a plane orthogonal to an axis of direction of the corresponding length, height or depth of the container. The container may be constructed of known packaging materials such as paperboard, corrugated paperboard, plastic, and the like. Preferably, the outer surface is formed from a corrugated construction. It will be understood that in a more preferred embodiment of the present invention especially when applied to heavy items a double wall or reinforced corrugated construction is desirable.

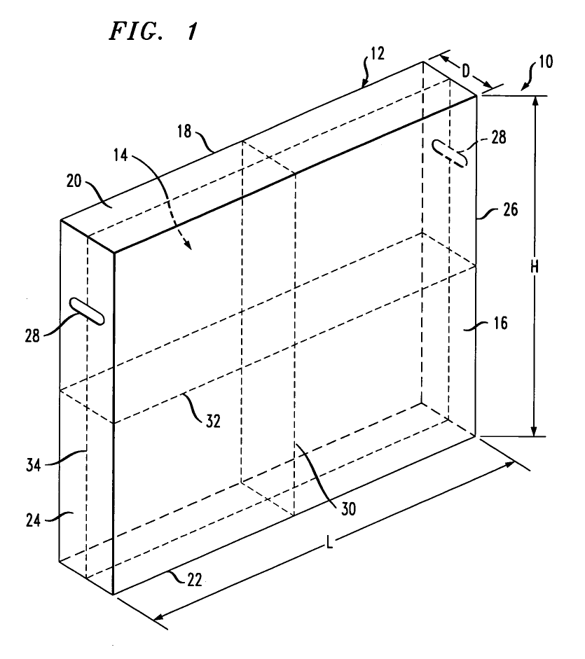

Referring to FIG. 1, a packaging system identified generally by reference numeral 10 is shown for one embodiment of the present invention. The packaging system 10 includes a container 12 having a length, L, a height, H, and a depth, D. In this embodiment, the container 12 is in the shape of a rectangular polygon. The container 12 is substantially enclosed to define an interior cavity 14, and further includes front and rear panels 16 and 18, top and bottom panels 20 and 22, and opposed side panels 24 and 26. The container 12 may optionally include handle-forming slots 28 located in the side panels 24 and 26, respectively, on opposed ends thereof. The handle forming slots 28 provide the user with a better grip and control during construction of the package and subsequent carry or transport of the packaged item.

It will be understood that the shape and configuration of the container of the packaging system of the present invention is not limited to the rectangular profile as shown and described herein, and may be modified to include other shapes and configurations which can be separated, and subsequently engaged with one another at the open ends thereof to form a telescoping closure relationship therebetween as will be described hereinafter.

The container 12 is constructed of suitable packaging materials such as paperboard, preferably corrugated paperboard, plastic and the like. The container 12 is preferably constructed from a rigid corrugated paperboard material with a relatively high burst strength rating. In a more preferred embodiment of the present invention, the rigid corrugated paperboard material is a standard grade kraft doublewall corrugated paperboard having a bursting strength (Mullen) of from about 200# to 1100# Test, preferably 200# to 600# Test, and more preferably about 350# Test. The Mullen test measures resistance to rupture in pounds per square inch (psi).

As shown in FIG. 1, the packaging system 10 includes one or more perforation lines 30, 32 or 34 along which a user can readily cut, split or separate through the corresponding panels of the container 12 to yield first and second container members as will be further described hereinafter. The perforation lines 30, 32 and 34 are produced by perforations fully or preferably partially extending through the corresponding panels 16, 18, 20, 22, 24 and 26 of the container 12. Alternatively, the perforation lines 30, 32 or 34 may be in the form of visibly marked score or tear lines intended to the aid the user in separating the container 12 into two pieces or members. The perforation lines should be sufficiently deep into the panels so that a standard razorblade type-cutting knife can be used to separate the container into two portions capable of being associated in a telescopic closure relationship. It will be understood that more than one perforation line can be used for each panel to enable the user to have more precise control over the size of the separated portions of the container.

In one embodiment of the present invention, the packaging system 10 includes a perforation line 30 extending and circumscribing the outer surface of the container 12, and oriented in a plane orthogonal to the axis of direction of the length, L. The perforation line 30 allows the container 12 to be adjusted lengthwise to accommodate a bulky and/or heavy item (not shown) as will be further described hereinafter. The perforation fine 30 may be suitably positioned at any point along the length, L, of the container 12 between the side panels 24 and 26.

The packaging system 10 includes a perforation line 32 extending and circumscribing the outer surface of the container 12, and oriented in a plane orthogonal to the axis of direction of the height, H. The perforation line 32 allows the container 12 to be adjusted height-wise to accommodate a bulky and/or heavy item (not shown). The perforation line 32 may be suitably positioned at any point along the height, H, of the container 12 between the top and bottom panels 20 and 22.

The packaging system 10 includes a perforation line 34 extending and circumscribing the outer surface of the container 12, and oriented in a plane orthogonal to the axis of direction of the depth, D. The perforation line 34 allows the container 12 to be adjusted depth-wise to accommodate a bulky and/or heavy item (not shown). The perforation line 34 may be suitably positioned at any point along the depth, D, of the container 12 between the front and rear panels 16 and 18.

It will be understood that the position and number of perforation lines is not limited to what is shown and described herein, and that the perforation lines may be provided in a single orientation or multiple orientations and with single or multiple perforation lines in each orientation evenly distributed in a spaced apart manner to better match the corresponding dimensions of a range of different size bulky and/or heavy items.

In a further embodiment of the present invention, there is provided a method for carrying an item, preferably bulky and/or heavy items, in which the method comprises the step of obtaining a packaging system including a container defining an interior cavity, and having an outer surface defining a length, a height and a depth, and at least one perforating line circumscribing the outer surface of the container, wherein the at least one perforating line is oriented in a plane orthogonal to an axis of direction of the corresponding length, height or depth of the container. Preferably, the outer surface is formed from a packaging material of rigid construction, and more preferably the packaging material is a reinforced or corrugated material and/or comprised of a double wall corrugated construction.

The method of the present invention, further includes the steps of cutting the container along one of the perforating lines to yield first and second container members each having an open end in communication with an interior area, inserting one end of a packaged item into the interior area of the first container member, placing an opposing end of the bulky and/or heavy item into the interior area of the second container member, and engaging the two open ends of the first and second container members in a telescoping closure relationship wherein the bulky and/or heavy item is enclosed within the interior areas of the telescoped first and second container members.

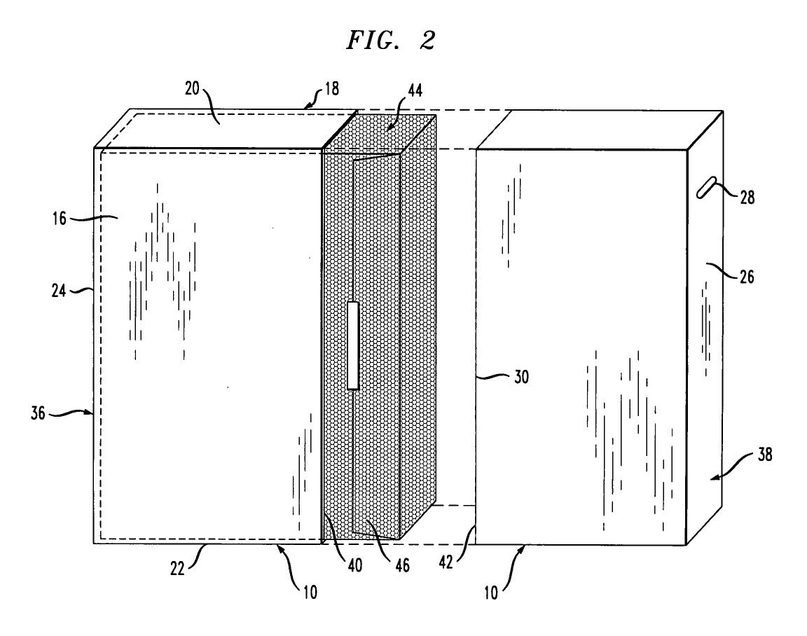

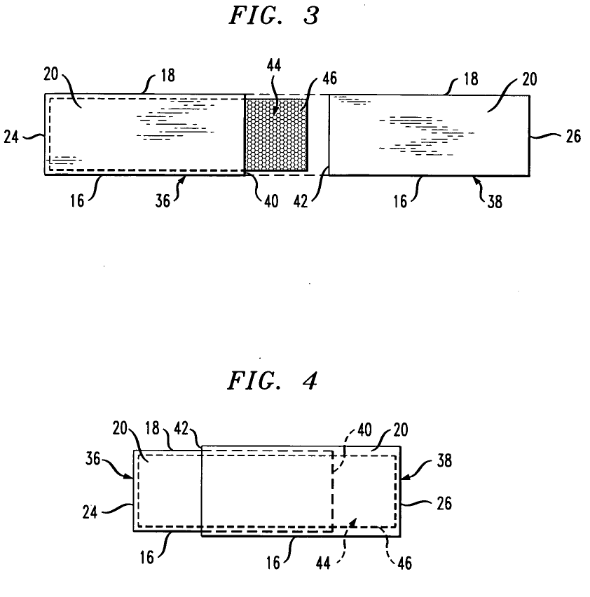

Referring to FIGS. 2 to 4, the packaging system 10 is separated along a perforation line 30 into first and second container members 36 and 38 to illustrate an example of the operation of the present invention. The separation may be achieved using a standard razorblade type of knife such as a so-called box cutter knife. The first and second container members 36 and 38 each include an open end 40 and 42, respectively. A bulky and/or heavy item 44 such as a flat screen television, optionally wrapped in a packing material 46 (e.g., Styrofoam, bubble wrap, moving blanket, and the like) is inserted into the first container member 36 through the corresponding open end 40 as shown in FIGS. 2 and 3.

Once the item 44 is securely seated within the first container member 36, the open end 40 of the first container member 36 is inserted into the second container member 38 through the open end 42 thereof in a telescoping closure relationship. The item 44 is properly seated within the packaging system 10 once it is pressed against the interior of the second container member 38 as shown in FIG. 4. Thus, the item 44 is securely retained and packaged therein and ready for carry and transport.

Optionally, the exposed open end 42 of the second container member 38 may be fixed firmly to the adjacent exterior portion of the first container member 36 through suitable fastening means including tape, glue or adhesive, staples and the like, to ensure secure enclosure of the packaged item 44.

It will be understood that as an alternative the telescoping closure relationship may be undertaken by inserting the open end 42 of the second container member 38 into the first container member 36 through the open end 40 thereof. The second container member 36 is packed in-between the item 44 and the interior of the first container 36. Similarly, in this alternative embodiment, the exposed open end 40 of the first container member 36 may optionally be fixed firmly to the adjacent exterior portion of the second container member 36 through suitable fastening means.

It is noted that the perforation line may be positioned on the container of the present invention in a manner that produces upon separation major and minor container members. The major member has a dimension (e.g., length) larger than the minor member. In such a case, it is preferred, during the packaging operation, that the open end of the major container member is inserted into the minor container member, so that the major container member is securely seated against the closed end portion of the minor container member. This arrangement produces a more rigid packaging structure for the packaged item contained therein.

In another embodiment of the present invention, the method may further comprise obtaining two packaging systems as defined above, perforating each of the packaging systems along a corresponding perforating line to yield a major container member from each, and utilizing the two major container members to package the item through a telescoping closure relationship therebetween employing the steps described above. These steps are implemented where the size of the item to be packaged is larger than what can be accommodated by a single packaging system of the present invention. Thus, the present invention may be utilized in this manner to further extend the size capacity of the packaging system without performing extensive modifications to existing parameters.

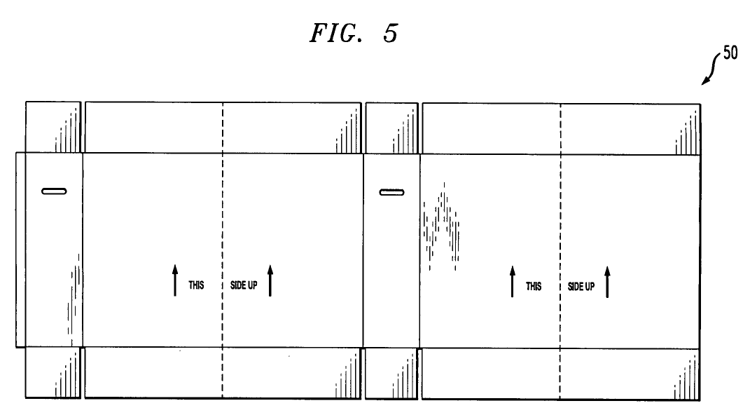

Referring to FIG. 5, a blank 50 is shown for forming a packaging system of the present invention. The blank 50 may be folded along fold lines and secured into the packaging system using suitable binding means in a conventional manner.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A packaging system for a carrying an item, preferably bulky and/or heavy items, said system comprising:
an enclosed container defining an interior cavity, and having an outer surface defining a length, a height and a depth; and
at least one perforating line circumscribing the outer surface of said container, said at least one perforating line oriented in a plane orthogonal to an axis of direction of the corresponding length, height or depth of the container.

2. A method for carrying an item, preferably bulky and/or heavy items, said method comprising the steps of:
obtaining a packaging system comprising:
(a) a container defining an interior cavity, and having an outer surface defining a length, a height and a depth; and
(b) at least one perforating line circumscribing the outer surface of said container, said at least one perforating line oriented in a plane orthogonal to an axis of direction of the corresponding length, height or depth of the container;
cutting along one of the at least one perforating line to yield first and second container members each having an open end in communication with an interior area;
inserting one end of a packaged item into the interior area of the first container member;
placing an opposing end of the bulky and/or heavy item into the interior area of the second container member; and
engaging the two open ends of the first and second container members in a telescoping closure relationship wherein the bulky and/or heavy item is enclosed within the interior areas of the telescoped first and second container members.

3. A blank for forming the packaging system of claim 1.
